(19) United States
(12) Patent Application Publication
(10) Pub. No.: US 2026/0142820 A1
(43) Pub. Date: May 21, 2026

(54) UNIVERSAL TRUST TOKEN STANDARD AND INTEROPERABLE CREDENTIAL WALLET PROTOCOL

(71) Applicant: George William Bickerstaff, III, Greenwich, CT (US)

(72) Inventor: George William Bickerstaff, III, Greenwich, CT (US)

(21) Appl. No.: 19/452,351

(22) Filed: Jan. 18, 2026

(51) Int. Cl. H04L 9/32

(52) U.S. Cl. CPC H04L 9/3213; H04L 9/3218; H04L 9/3247

(57) ABSTRACT

A universal trust token standard and interoperable credential wallet protocol enable portable, verifiable, and policy-constrained trust credentials across platforms. Trust tokens package claims, trust scores, provenance commitments, and policies, while wallets generate selective disclosure proofs and verifiers produce auditable receipts, creating a universal trust substrate for digital ecosystems.

### TECHNICAL FIELD

The present invention relates to computer-implemented systems for identity, credentialing, authorization, and governance across digital platforms.

More particularly, the invention relates to a universal, portable trust token standard and an interoperable credential wallet protocol enabling verifiable, policy-constrained trust credentials to be issued, stored, selectively disclosed, verified, revoked, and audited across heterogeneous platforms and jurisdictions.

### BACKGROUND

Digital platforms increasingly require reliable signals of identity, eligibility, authority, competence, and compliance to grant access, authorize actions, or allocate responsibility.

Existing identity and credential systems are fragmented, platform-specific, and tightly coupled to proprietary account infrastructures, making trust credentials difficult to reuse across systems.

Reputation scores, professional credentials, and compliance attestations often lack cryptographic verifiability, consistent governance semantics, and standardized auditability.

Credential wallet approaches exist, but most lack standardized policy enforcement, interoperable mappings to enterprise and decentralized systems, and robust revocation or lifecycle control.

In regulated and high-risk environments, verification must be purpose-limited, privacy-preserving, and accompanied by defensible audit evidence.

Current systems do not provide a universal trust object that is portable across platforms while remaining verifiable, enforceable, and auditable.

Accordingly, there exists a need for a universal trust token standard and interoperable wallet protocol that functions as a shared trust substrate across platforms, industries, and governance regimes.

### SUMMARY OF THE INVENTION

The disclosed invention provides a Universal Trust Token standard and an interoperable credential wallet protocol.

A trust token schema engine generates standardized trust tokens comprising verified claims, normalized trust scores, provenance commitments, and machine-readable policy constraints.

A credential wallet securely stores trust tokens and generates selective disclosure proofs responsive to verifier requests while enforcing embedded policies.

A verification and interoperability layer validates disclosures, enforces purpose limitation, checks revocation status, and maps verification outcomes into multiple external protocols.

An audit and governance layer generates immutable verification receipts supporting compliance, billing, and dispute resolution.

### DEFINITIONS

Audit Receipt: A cryptographically signed record documenting a verification event, including purpose, verifier identity, token reference, and timestamp.
Credential Wallet: A hardware, software, or hybrid component configured to store trust tokens, manage keys, enforce policies, and generate selective disclosures.
Interoperability Adapter: A translation component mapping trust tokens and verification outcomes into external identity or authorization formats.
Policy Constraint: A machine-readable rule defining permitted uses, disclosure scope, retention limits, or verifier eligibility.
Provenance Commitment: A cryptographic binding between a claim and its evidence, issuer identity, and issuance context.
Revocation Registry: A service or data structure indicating whether a trust token or claim is revoked, suspended, or expired.
Selective Disclosure Proof: A cryptographic proof revealing only required attributes of a trust token while withholding others.
Trust Score: A normalized scalar or vector representing credibility, reliability, or authority derived from verified signals.
Trust Token: A standardized credential object comprising claims, trust scores, provenance commitments, and policy constraints.
Verification Challenge: A verifier-issued cryptographic request binding a disclosure to a specific verification event.

### BRIEF DESCRIPTION OF THE DRAWINGS

FIG. 1 illustrates a universal trust token system architecture.

FIG. 2 illustrates trust token structure and cryptographic bindings.

FIG. 3 illustrates selective disclosure and verification workflows.

FIG. 4 illustrates interoperability mappings across platforms and protocols.

FIG. 5 illustrates governance, revocation, and lifecycle management.

### DETAILED DESCRIPTION

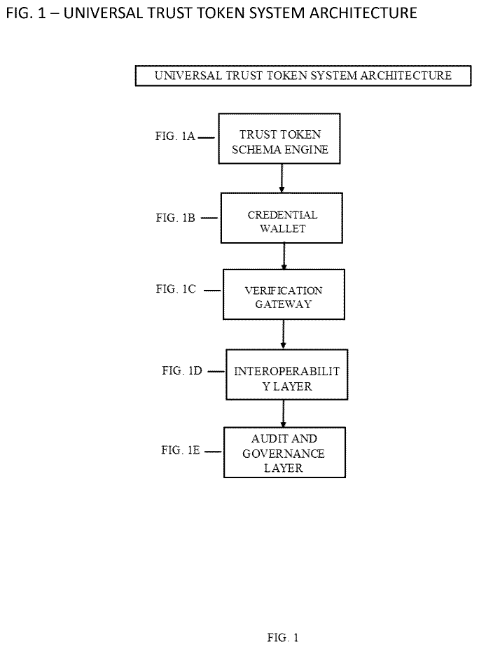

### FIG. 1—Universal Trust Token System Architecture

FIG. 1 illustrates a system architecture comprising a trust token schema engine, a credential wallet, a verification gateway, and an audit and governance layer. The architecture separates issuance, storage, verification, and auditing to preserve portability and enforceability. All components communicate using cryptographically verifiable artifacts.

### FIG. 1A—Trust Token Schema Engine

FIG. 1A illustrates a schema engine that constructs trust tokens from verified inputs. The engine standardizes claim formats, trust score representation, and policy encoding. Versioning is supported for backward compatibility.

### FIG. 1B—Credential Wallet

FIG. 1B illustrates a credential wallet that securely stores trust tokens and cryptographic keys. The wallet enforces policy constraints locally before responding to requests. Hardware-backed security may be used.

### FIG. 1C—Verification Gateway

FIG. 1C illustrates a verification gateway that receives verifier requests and validates selective disclosure proofs. The gateway checks issuer signatures, provenance commitments, and revocation status. Policy constraints are enforced prior to approval.

### FIG. 1D—Interoperability Layer

FIG. 1D illustrates an interoperability layer mapping verification outcomes into external systems. Mappings preserve semantics while adapting formats. Adoption does not require infrastructure replacement.

### FIG. 1E—Audit and Governance Layer

FIG. 1E illustrates generation and storage of audit receipts. Receipts are immutable and minimal. Governance oversight is supported.

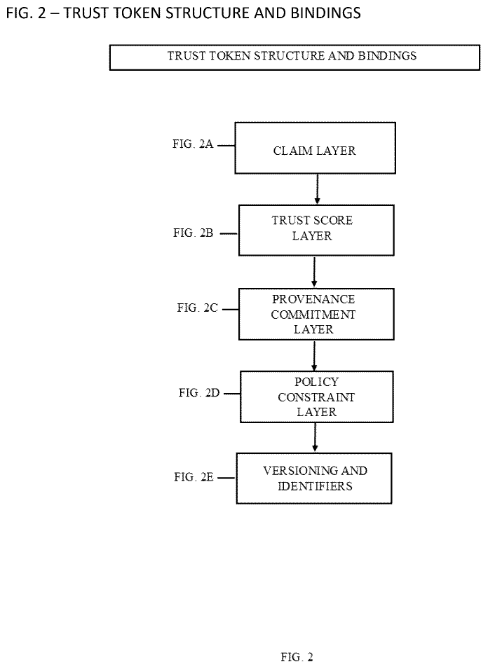

### FIG. 2—Trust Token Structure and Bindings

FIG. 2 illustrates internal structure of a trust token. Layers are cryptographically bound. Selective disclosure is supported.

### FIG. 2A—Claim Layer

FIG. 2A illustrates claim fields representing identity, credentials, approvals, or permissions. Claims use standardized namespaces. Expiration and renewal metadata may be included.

### FIG. 2B—Trust Score Layer

FIG. 2B illustrates trust score representation. Scores may be multidimensional. Threshold proofs are supported.

### FIG. 2C—Provenance Commitment Layer

FIG. 2C illustrates cryptographic commitments binding claims to evidence. Evidence is not disclosed. Integrity remains verifiable.

### FIG. 2D—Policy Constraint Layer

FIG. 2D illustrates embedded policy constraints. Purpose limitation and retention rules are encoded. Enforcement occurs at wallet and verifier.

### FIG. 2E—Versioning And Identifiers

FIG. 2E illustrates token identifiers and version metadata. Compatibility is preserved across upgrades. Verifiers interpret tokens unambiguously.

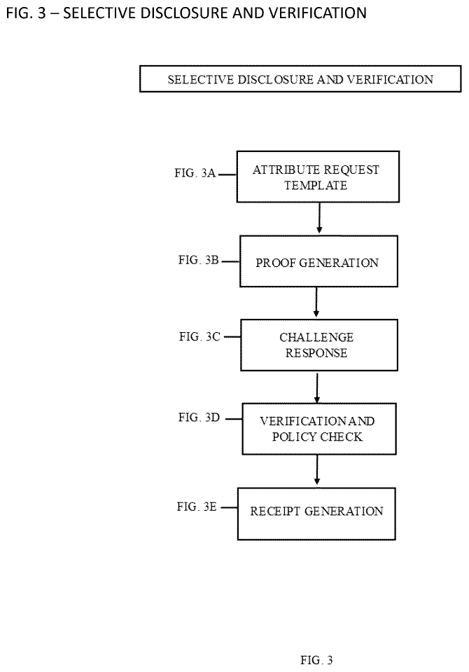

### FIG. 3—Selective Disclosure and Verification

FIG. 3 illustrates end-to-end selective disclosure workflows. Disclosure is minimal. Verification remains enforceable.

### FIG. 3A—Attribute Request Template

FIG. 3A illustrates verifier requests specifying attributes and purpose. Requests are machine-readable. Wallets evaluate compliance.

### FIG. 3B—Proof Generation

FIG. 3B illustrates generation of selective disclosure proofs. Only required attributes are revealed. Withheld attributes remain private.

### FIG. 3C—Challenge Response

FIG. 3C illustrates nonce-based challenge binding. Replay is prevented. Control is demonstrated.

### FIG. 3D—Verification and Policy Check

FIG. 3D illustrates validation of proofs and policy constraints. Revocation status is checked. Non-compliant requests are denied.

### FIG. 3E—Receipt Generation

FIG. 3E illustrates audit receipt creation. Receipts reference verified attribute sets. Raw data is not stored.

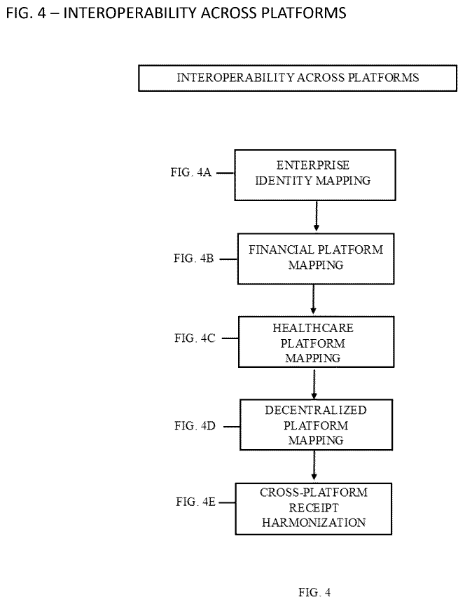

### FIG. 4—Interoperability Across Platforms

FIG. 4 illustrates protocol interoperability. Trust becomes portable. Platforms integrate without replacement.

### FIG. 4A—Enterprise Identity Mapping

FIG. 4A illustrates mapping into enterprise identity systems. Access is gated by trust verification. Audit trails are preserved.

### FIG. 4B—Financial Platform Mapping

FIG. 4B illustrates mapping into banking or payment systems. Trust tokens gate transactions. Risk is reduced.

### FIG. 4C—Healthcare Platform Mapping

FIG. 4C illustrates mapping into clinical systems. Credentials are verified without duplication. Compliance is enforced.

### FIG. 4D—Decentralized Platform Mapping

FIG. 4D illustrates mapping into decentralized protocols. Smart contracts consume verification results. Privacy is preserved.

### FIG. 4E—Cross-Platform Receipt Harmonization

FIG. 4E illustrates normalization of audit receipts. Reporting is unified. Governance scales.

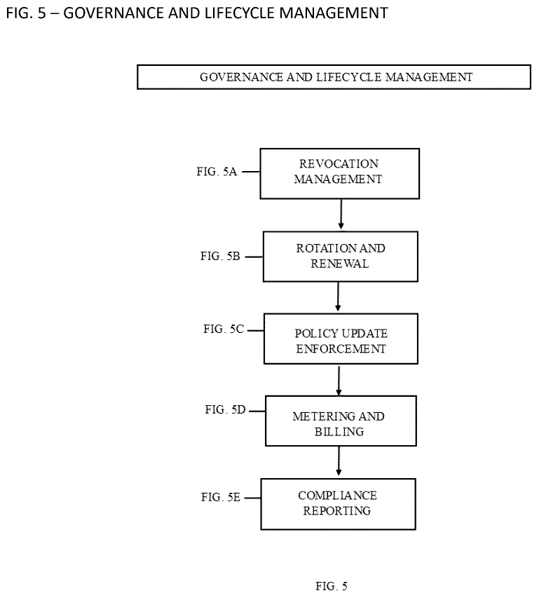

### FIG. 5—Governance and Lifecycle Management

FIG. 5 illustrates lifecycle control of trust tokens. Governance is continuous. Risk is contained.

### FIG. 5A—Revocation Management

FIG. 5A illustrates revocation registry synchronization. Verifiers check freshness. Compromised tokens are invalidated.

### FIG. 5B—Rotation and Renewal

FIG. 5B illustrates key rotation and token renewal. Long-term risk is reduced. Continuity is preserved.

### FIG. 5C—Policy Update Enforcement

FIG. 5C illustrates dynamic policy updates. Existing tokens adapt. Governance evolves.

### FIG. 5D—Metering and Billing

FIG. 5D illustrates metering of verification events. Usage is auditable. Commercial models are enabled.

### FIG. 5E—Compliance Reporting

FIG. 5E illustrates generation of compliance reports. Receipts serve as evidence. Disputes are resolvable.

### Example

In one example, a professional uses a credential wallet containing trust tokens representing verified identity, professional licensing, governance approvals, and performance trust scores. The same wallet is used across employment platforms, financial institutions, clinical systems, and decentralized applications.

When accessing a regulated system, the verifier requests proof of specific attributes for a defined purpose. The wallet generates a selective disclosure proof satisfying the request without revealing unrelated credentials or scores.

The verifier validates the proof, enforces policy constraints, and generates an audit receipt. The professional gains access instantly across platforms without re-verification, while governance, privacy, and auditability are preserved.

1. A computer-implemented system for portable trust credential verification, comprising:
a trust token schema engine configured to generate standardized trust tokens;
a credential wallet configured to store trust tokens and generate selective disclosure proofs;
a verification gateway configured to validate disclosures and enforce policy constraints; and
an audit layer configured to generate cryptographically signed verification receipts.

2. A computer-implemented method for interoperable trust verification, comprising:
issuing a trust token comprising claims, trust scores, provenance commitments, and policy constraints;
storing the trust token in a credential wallet;
receiving a verifier request specifying attributes and purpose;
generating a selective disclosure proof;
verifying the proof and enforcing policy constraints; and
generating an audit receipt.

3. A non-transitory computer-readable medium storing instructions that, when executed, cause performance of operations comprising generating trust tokens, selectively disclosing attributes, verifying proofs, and recording audit receipts.

4. The system of claim 1, wherein the trust token includes a normalized trust score.

5. The system of claim 1, wherein policy constraints include purpose limitation or retention rules.

6. The system of claim 1, wherein selective disclosure proofs include threshold proofs.

7. The system of claim 1, wherein verification includes revocation registry checks.

8. The system of claim 1, wherein the interoperability layer maps verification outcomes into enterprise identity protocols.

9. The method of claim 2, further comprising issuing a verification challenge nonce.

10. The system of claim 1, wherein audit receipts are stored in an immutable log.
